(19) United States
(12) Patent Application Publication
(10) Pub. No.: US 2007/0196795 A1
(43) Pub. Date: Aug. 23, 2007

(54) ANIMATION-BASED SYSTEM AND METHOD FOR LEARNING A FOREIGN LANGUAGE

(76) Inventor: Bradley K. GROFF, Marietta, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/677,095

(22) Filed: Feb. 21, 2007

Related U.S. Application Data
(60) Provisional application No. 60/775,134, filed on Feb. 21, 2006.

(51) Int. Cl. G09B 19/00

(52) U.S. Cl. 434/156

(57) ABSTRACT

A program and method for language instruction, wherein a student watches an animated audiovisual program in a first language and in a second language, and the video portion of the program is coherent with the audio portion of the program in both the first and second languages.

### CROSS-REFERENCE TO RELATED APPLICATION

This application claims the benefit of U.S. Provisional Patent Application Ser. No. 60/775,134, filed Feb. 21, 2006, which application is incorporated by reference in its entirety herein.

### TECHNICAL FIELD

The present invention relates generally to a system and method for learning a foreign language, and more particularly to an animated audiovisual program presented in two or more languages in a manner that promotes attentiveness and focus in learning a foreign language by providing coherent multi-lingual entertainment to the student.

### BACKGROUND OF THE INVENTION

Previously known methods of learning a foreign language are often tedious and dull. As a result, many students fail to devote sufficient time and effort to develop their desired level of foreign language skills.

For example, many prior language programs consist of audio lessons having a foreign language speaker repeating individual phrases over and over, with native language translations interspersed therewith. Often a workbook is provided to allow the student to read along with the audio program. Many students quickly lose interest in such rote methods of learning.

In other language programs, audio and video are combined, in an effort to make the program more interesting to the student. The video portion of the program is typically a recording of live actors speaking in either the foreign or native language. As a result, when the audio program of the other language is dubbed onto the program, the speakers' lip movements do not match the audio being heard. This incoherence of the audio and video portions of the program is distracting on a conscious or subconscious level, and the student's full attention is not directed to learning the language. Other programs may incorporate recordings of live actors, wherein the same actor presents one portion of the program in a first language and another portion of the program in a second language, or wherein different actors present the same script in different languages. These forms of instruction based on audio and/or video recordings of actual human presenters may introduce distractions due to a lack of coherence between the first language portion and the second language portion of the program, and/or may introduce inaccuracies resulting from an actor speaking in a non-native tongue.

Thus it can be seen that needs exist for improvements to methods and systems for learning foreign language skills. It is to the provision of an improved system and method for learning a foreign language meeting this and other needs that the present invention is primarily directed.

### SUMMARY OF THE INVENTION

In example forms, the present invention is an improved system and method for learning a foreign language. The invention provides an animated (i.e., cartoon) audiovisual program presented in two or more languages, wherein the audio and video portions of the program are coherent in each language presented. In this manner, the student is not distracted by a mismatch between a video portion recorded in one language and an overdubbed audio portion in a second language.

The animated audiovisual program is preferably a popular entertainment program having wide audience appeal. In this manner, a large cross-section of students will find the program enjoyable and entertaining. For the students, this has the advantage of increasing attentiveness and enjoyment during the learning experience, making it both more effective and more fun, and leading to better learning. For the program provider, this has the advantage of greater market appeal and resultant increased sales.

In one aspect, the invention is a program for language instruction, preferably including an animated audiovisual program presented in a first language and in a second language, wherein the video portion of the program is coherent with the audio portion of the program in both the first and second languages.

In another aspect, the invention is a method of language instruction. The method preferably includes viewing at least a portion of an animated audiovisual program in a first language, and viewing at least a corresponding portion of the animated audiovisual program in a second language, wherein the video portion of the program is coherent with the audio portion of the program in both the first language and the second language.

In still another aspect, the invention is an element of audiovisual recording media having a language instruction program recorded thereon. The language instruction program preferably includes an animated audiovisual program presented in a first language and in a second language, wherein the video portion of the program is coherent with the audio portion of the program in both the first and second languages.

In an example embodiment, the element of audiovisual recording media having the language instruction program recorded thereon is in the form of a DVD.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1a shows a first language portion of an animated audiovisual program for learning a foreign language according to an example form of the invention.

FIG. 1b shows a second language portion of the animated audiovisual program for learning a foreign language.

FIG. 2 shows an audiovisual recording media containing an animated audiovisual program for learning a foreign language according to an example form of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

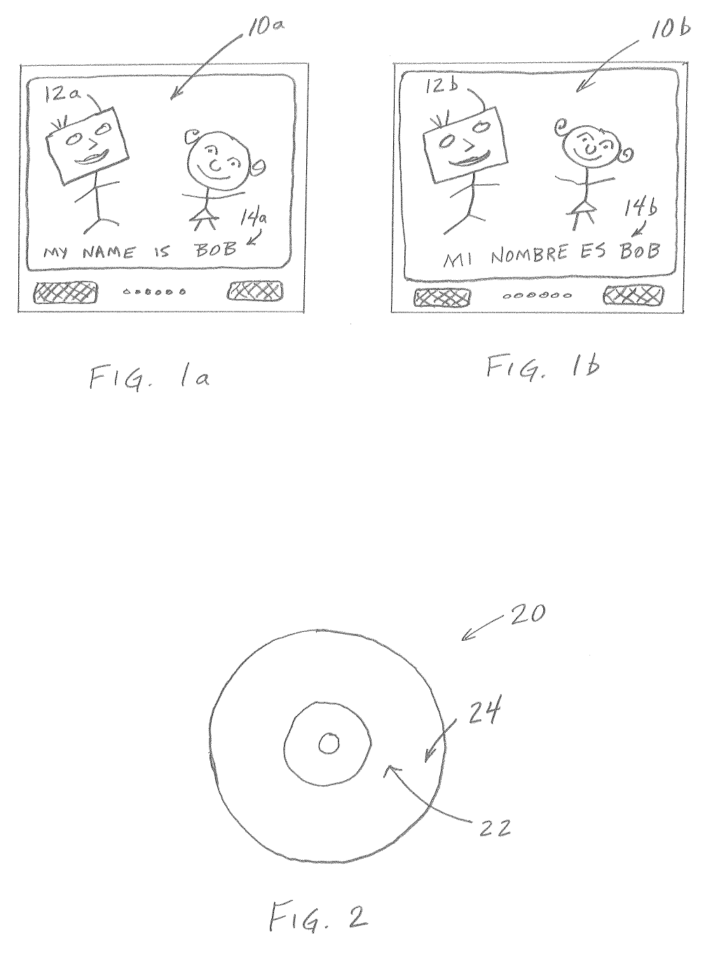

With reference now to the drawing figures, FIGS. 1a and 1b show an animated audiovisual program 10a, 10b in a first language (English) and a second language (Spanish), respectively. The program in the first language preferably follows a substantially identical plot, script and storyline as the program in the second language, except that the programs are presented in different languages. The first language may be, for example, the native language of the targeted language student, and the second language the foreign language the student desires to learn.

Both the first language portion and the second language portion of the animated audiovisual program 10a, 10b are preferably produced with coherent audio and video components. For example, the video character animation corresponding to the English audio portion has visually perceptible mouth movements corresponding to the words of the English-spoken audio content, and the character animation corresponding to the Spanish audio portion has different visually perceptible mouth movements corresponding to the words of the Spanish-spoken audio content. In addition to the mouth movements of a program character 12 who is speaking in a given language, the overall facial movements and body language and gesturing of the speaking character, as well as the expressions and reactions of other characters, optionally also follow the spoken script of each language respectively in a manner providing overall coherence between the spoken-audio and video portions of the program in each language. This may be accomplished by providing entirely separate video animations for each audio language under a common storyline, or by separate partial animations of only the characters' mouths, facial features, hands, and/or other specified body portions. The animation can be computer-generated or computer assisted, or alternatively can be hand-drawn animation, according to known form. The spoken-audio portions in each language can comprise recorded human speakers, with the same speaker providing the spoken audio for a given character in each of the two or more program languages, preferably a speaker of high fluency in both languages; or with different speakers for each language, the speakers preferably having similar voices, for improved coherency between languages. Alternatively or additionally, the spoken-audio portions can comprise computer-generated voices.

The video portion of the program optionally also includes text subtitles 14 transcribing the audio portion in both the first and second languages. The text subtitles 14 may be useful for hearing-impaired students, and for other students who learn better by visualizing written words as well as hearing them spoken. The subtitles may be provided in combination with, or in place of, the audio portion of the program. The text subtitles 14 also help teach spelling and grammar in the language being learned. The subtitles, if provided, preferably allow a user to selectively switch them on and off; and/or the subtitles are automatically displayed and removed at different points of the program selected to enhance learning and retention. The system preferably also allows the user to selectively switch between showing the subtitles in the same language as the video portion of the animation being displayed, or in the other language (e.g., the audiovisual animation in the first language can be presented in combination with subtitles in either the first language or subtitles in the second language, and likewise the audiovisual animation in the second language can be presented in combination with subtitles in either the second language or subtitles in the first language).

The first language portion and the second language portion of the animated audiovisual program 10a, 10b are preferably recorded on a single element of audiovisual recording media, such as for example a DVD 20 as shown in FIG. 2. The DVD 20, for example, comprises one or more tracks 22 containing the coherent audio and video portions of the program in the first language, and one or more corresponding tracks 24 containing the coherent audio and video portions of the same program in the second language. The first language portion and the second language portion of the animated audiovisual program are optionally divided into discrete partial program segments, with the program segments of both the first language portion and the second language portion corresponding to the same parts of the plot or script of the overall program, so that a user can alternate between coherent partial segments in the first language and then in the second language. The partial program segments can be of a defined time period (e.g., one minute, five minutes, etc.), or can correspond to transitions in the program story-line, breaks in recorded conversation, or commercial breaks provided for sponsor advertising spots in an existing commercial television program comprising the animated audiovisual program of the present invention. In alternate embodiments, portions of the program are separately recorded on multiple audiovisual recording media elements. And in further alternate forms of the invention, the program is provided in other formats or on other types of media, such as without limitation, one or more VHS tapes, computer-readable CDs, computer hard-drives, flash memory, high-definition DVDs, streamed audiovisual content, satellite or cable-delivered content, internet or website-delivered content, and/or various other storage or delivery formats now existing or developed in the future.

The animated audiovisual program preferably comprises or is based upon an already existing popular entertainment program, such as a television show, video series, movie, or webcast, with wide and diverse audience appeal. In particular examples, the program includes a multi-character family unit, and a variety of non-family characters in various real-world roles, so that the student is exposed to common family experiences, work and professional experiences, leisure experiences, and the like, in each of the two or more languages included in the program, to enhance the learning experience. For example, the program may include animated characters such as: a father, a mother, male and female siblings, policemen, firemen, a bartender, a convenience store clerk, co-workers, a religious leader, television personalities, a school teacher, a politician, and the like. The animated characters may be human in form, or alternatively may be based on aquatic or terrestrial animals, inanimate objects given fanciful anthropomorphic characteristics, or entirely fabricated creatures of the imagination. In further examples, the program includes a series of two or more episodes, each episode presenting the characters in different situations to present different learning experiences in a fresh and entertaining manner.

In addition to animated programming, the invention also includes programs incorporating real human actors, wherein the program is separately filmed or staged live in each of the two or more languages.

The method of the present invention preferably includes sequentially viewing at least a portion of the program in a first language and at least a portion of the program in a second language, wherein the viewed portions in each language correspond to the same program plot segments. For example, a native English speaking student seeking to learn Spanish will watch and listen to all or a portion of the audiovisual program in English to learn the plot and hear the audio portion in an easily understood language. Then the student will watch and listen to all or the same plot portion of the audiovisual program in Spanish. Optionally, the method of the present invention includes alternating back and forth between program segments in the first language and corresponding coherent program segments in the second language, either under user-selective control or according to a prescribed program selected to optimize learning and retention. Optionally also, the method of the present invention includes selectively activating textual subtitles corresponding to the audio portion of the program being presented. Knowing the plot, and remembering at least some of the spoken dialog of the program's script from viewing the program in their native language, the student will be better able to recognize the corresponding portions of the program in their non-native language and thereby absorb and learn the non-native language. Some or all of the program in either or both languages can be replayed as desired, to assist in learning and/or reinforcing what has been learned.

Various forms of program instructions can be included along with or in combination with the audiovisual program, to assist in the student's learning process. For example, program instructions can be provided as part of the audiovisual programming, on separate tracks of the media containing or delivering the program, and/or in separate workbooks or electronic media. The instructions may provide a recommended course of study, recommended viewing sequences, recommended frequency or number of viewings in each language, etc. In further example embodiments, the student is prompted to speak along with one or more characters, either by lesson scripts provided on or along with the audiovisual program, or in separate instructions provided in combination with the audiovisual program. Because many viewers commonly speak along with the “lines” of entertainment programs they have previously viewed and remembered, this part of the exercise will be seen as fun, rather than work. In further embodiments of the invention, the audio portion of the program corresponding to one or more characters can be muted during playback, either manually by the student or automatically by the program, so that the student can fill in that character's spoken lines, providing for a more interactive learning experience.

While the invention has been described with reference to preferred and example embodiments, it will be understood by those skilled in the art that a variety of modifications, additions and deletions are within the scope of the invention, as defined by the following claims.

What is claimed is:

1. A program for language instruction comprising an animated audiovisual program presented in a first language and in a second language, wherein a video portion of the program is coherent with an audio portion of the program in both the first and second languages.

2. The program of claim 1, wherein the audio and video portions of the program in both the first and second languages are recorded on a single element of audiovisual recording media.

3. The program of claim 2, wherein the single element of audiovisual recording media comprises a DVD.

4. The program of claim 1, wherein the animated audiovisual program comprises animated characters of an already existing popular entertainment program.

5. The program of claim 4, wherein the animated audiovisual program comprises at least one episode of the popular entertainment program, the at least one episode being animated in both the first language and the second language.

6. The program of claim 1, further comprising textual subtitling corresponding to the audio portion of the program in at least one of the first and second languages.

7. The program of claim 6, wherein the textual subtitling corresponds to the audio portion of the program in both of the first and second languages.

8. The program of claim 7, wherein the textual subtitling is selectively switchable between text in the first language and text in the second language.

9. The program of claim 1, further comprising teaching instructions directing a course of study based on the animated audiovisual program.

10. The program of claim 9, wherein the teaching instructions and the audio and video portions of the program in both the first and second languages are recorded on a single element of audiovisual recording media.

11. The program of claim 1, wherein the animated audiovisual program is divided into a plurality of discrete program segments in both the first language and the second language, and wherein each program segment of the first language corresponds to a program segment of the second language presenting a like story-line portion of the animated audiovisual program.

12. The program of claim 11, wherein each of the program segments are of a defined time period.

13. The program of claim 11, wherein the program segments are divided by commercial breaks provided in an existing program.

14. A method of language instruction comprising viewing at least a portion of an animated audiovisual program in a first language, and viewing at least a corresponding portion of the same animated audiovisual program in a second language, wherein the video portion of the program is coherent with the audio portion of the program in both the first language and the second language.

15. The method of claim 14, comprising selectively switching between the first language portion of the program and the corresponding second language portion of the program, wherein the first language portion and the second language portion reside on the same audiovisual media element.

16. The method of claim 14, further comprising presenting teaching instructions directing a course of study based on the animated audiovisual program.

17. The method of claim 16, wherein the teaching instructions direct a user to repeat selected words of the program in one of the first and second languages.

18. The method of claim 17, wherein the selected words of the program to be repeated comprise a portion of a script of the program corresponding to lines of one character of the program.

19. An audiovisual recording comprising a language instruction program residing thereon, said language instruction program comprising an animated audiovisual program presented in a first language and in a second language, wherein the video portion of the program is coherent with the audio portion of the program in both the first and second languages.

20. The audiovisual recording of claim 19, comprising a DVD having the language instruction program recorded thereon.
